(19) United States
(12) Patent Application Publication
(10) Pub. No.: US 2010/0124317 A1
(43) Pub. Date: May 20, 2010

(54) SYSTEM AND METHOD FOR CALL WAITING SIGNAL RESPONSES

(76) Inventors: Didi Avraham Mecilati, Kiryat Ono (IL); Shalom Messilaty, Newlett, NY (US)

Correspondence Address: DANIEL J SWIRSKY, 55 REUVEN ST., BEIT SHEMESH, 99544, IL

(21) Appl. No.: 12/621,530

(22) Filed: Nov. 19, 2009

(30) Foreign Application Priority Data
Aug. 16, 2008 (IL) IL 200,422

(51) Int. Cl. H04M 1/64; H04M 3/42

(52) U.S. Cl. 379/88.23; 379/215.01

(57) ABSTRACT

A prepared response communication system includes a receiver to receive response codes from at least a first communications device, and a call response module to respond in accordance with the response codes to an attempt by a second communications device to call the first communications device. A communications device includes an incoming call interceptor to intercept incoming calls from at least a second device, and an incoming call response application to enable a user of the communications device to respond in a pre-determined manner to the second device.

### CROSS-REFERENCE TO RELATED APPLICATIONS

This application claims benefit of priority right from Israel Patent Application No. 200422, filed Aug. 16, 2009, which is hereby incorporated in its entirety by reference.

### FIELD OF THE INVENTION

The invention relates to call waiting generally and to managing pre-prepared responses to call waiting signals in particular.

### BACKGROUND OF THE INVENTION

Call waiting is known in the art. It is not uncommon for an incoming telephone call to come in while a telephone user is already engaged in a telephone conversation with someone else. In such cases, a call waiting signal alerts the telephone user that someone else is trying to call. The caller of the incoming call is also typically alerted to the situation by a change in the ringtone.

Telephone users typically respond in one of three ways to a call waiting signal. They either put the original call on hold in order to speak with the incoming caller before returning to the original call; disconnect the original call in order to speak with the incoming caller; or ignore the incoming call. Later, the telephone user may or may not attempt to call back one or both of the call partners, depending on, among other considerations, the original response.

Each typical response has possible drawbacks. The partner to the original call may understandably be annoyed if the call is put on hold or disconnected. Similarly, the incoming caller may be annoyed if the incoming call is ignored. The telephone user may therefore be inconvenienced by the incoming call no matter what the response may be; at least one if not both call partners will likely be annoyed. Furthermore, the situation may get worse if the telephone user promises to call back one or both partners and then fails to do so for whatever reason.

For these reasons and others, many telephone users elect to turn off call waiting functionality, such that incoming callers receive a busy signal when the telephone user is already engaged in a call with someone else.

### SUMMARY OF THE INVENTION

There is provided, in accordance with a preferred embodiment of the invention, a prepared response communication system including a receiver to receive response codes from at least a first communications device, and a call response module to respond in accordance with the response codes to an attempt by a second communications device to call the first communications device.

Further, in accordance with a preferred embodiment of the invention, the call response module includes a response code interpreter to interpret the response codes received from the first communications device while the second communications device attempts to call the first communications device, and a responder to at least send a pre-prepared response on behalf of the first communications device to the second communications device as per interpretation by the interpreter.

Still further, in accordance with a preferred embodiment of the invention, the call response module also includes a database of pre-prepared responses associated with the response codes.

Additionally, in accordance with a preferred embodiment of the invention, the pre-prepared responses are at least one of pre-recorded audio messages and actions.

Moreover, in accordance with a preferred embodiment of the invention, the call response module is configured to process the response codes in response to a call waiting situation, where such situation occurs when the first communications device is already engaged with in a call with a third communications device when called by the second communications device.

Further, in accordance with a preferred embodiment of the invention, the actions are at least one of answer, hang up, call back, send an SMS, send an email, and set a reminder.

Still further claim 1 and where the call response module is implemented as part of a communications switch.

Additionally, in accordance with a preferred embodiment of the invention, the call response module is implemented as a server in communication with at least one of the first communications device and a communications switch.

Moreover, in accordance with a preferred embodiment of the invention, the response codes are received via a voice connection.

Further, in accordance with a preferred embodiment of the invention, the response codes are received via a data connection between the first communications device and the call waiting response module.

There is also provided, in accordance with a preferred embodiment of the invention, a method to be implemented on a computing device for sending prepared responses to an incoming caller, the method including receiving a response code from a first communications device, where the first communications device is being called by a second communications device, interpreting the response code as a desired response, and responding to the second communications device in accordance with the desired response.

Further, in accordance with a preferred embodiment of the invention, the interpreting includes looking up the response code in a database of pre-prepared the desired responses, where at least one of the desired responses is associated with a user of the first communications device.

Still further, in accordance with a preferred embodiment of the invention, the responding includes at least sending a pre-recorded audio response to the second communications device on behalf of a user of the first communications device.

Additionally, in accordance with a preferred embodiment of the invention, the responding includes at least performing a pre-selected action on behalf of a user of the first communications device.

Moreover, in accordance with a preferred embodiment of the invention, the pre-selected action is at least one of hanging up, answering, sending an electronic message, and calling back the second communications device.

Further, in accordance with a preferred embodiment of the invention, the calling back includes at least one of calling back the second communications device according to pre-determined timing schedule, and calling back the second communications device upon completion of a current call with another communications device.

Still further, in accordance with a preferred embodiment of the invention, the computing device is integrated within a communications switch.

Additionally, in accordance with a preferred embodiment of the invention, the computing device is response server implemented independently of a communications switch.

Moreover, in accordance with a preferred embodiment of the invention, the receiving is via at least one of a data connection and a voice connection.

There is also provided, in accordance with a preferred embodiment of the invention, a communications device including an incoming call interceptor to intercept incoming calls from at least a second device, and an incoming call response application to enable a user of the communications device to respond in a pre-determined manner to the second device.

Further, in accordance with a preferred embodiment of the invention, the incoming call response application includes a response code receiver to receive the response codes input by the user, a response interpreter to interpret the response codes as desired responses by the user to the incoming calls, and a responder to forward the desired responses as necessary to at least the second communications device.

Still further, in accordance with a preferred embodiment of the invention, the device also includes a responses database to associate the response codes to the desired responses.

Additionally, in accordance with a preferred embodiment of the invention, the interceptor includes means to intercept the incoming phone call prior to their processing by a phone application.

Moreover, in accordance with a preferred embodiment of the invention, the desired responses are at least one of a pre-recorded message and an action.

Further, in accordance with a preferred embodiment of the invention, the responder includes means to answer the incoming call and at least initiate play of the pre-recorded message as indicated by the desired responses.

Still further, in accordance with a preferred embodiment of the invention, the responder includes means to launch a built-in phone application to call back the second communications device according to a schedule indicated by the desired responses.

Additionally, in accordance with a preferred embodiment of the invention, the schedule is at least one of a set time of day, a number of hours/minutes in the future, and upon completion of an ongoing call with another communications device.

Moreover, in accordance with a preferred embodiment of the invention, the interceptor is configurable to intercept incoming “call waiting” calls, where the communications device is already engaged in a call with another communications device.

There is also provided, in accordance with a preferred embodiment of the invention, in accordance with a preferred embodiment of the invention, a method implementable on a communications device for providing prepared responses to incoming telephone calls, the method including intercepting an incoming call from a second communications device, receiving a user-input response code, and responding to the incoming call with a prepared response associated with the response code.

Further, in accordance with a preferred embodiment of the invention, the method also includes interpreting the response code as a desired response by looking it up in a pre-prepared response database.

Still further, in accordance with a preferred embodiment of the invention, the desired response is at least one of a pre-recorded message and an action.

Moreover, in accordance with a preferred embodiment of the invention, the responding includes answering the incoming call and initiating the play of the pre-recorded message.

Further, in accordance with a preferred embodiment of the invention, the responding includes calling back the second communications device in accordance with timing indicated by the action.

Still further, in accordance with a preferred embodiment of the invention, claim 33 and where the timing may be upon conclusion of a current call with another communications device.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a novel call waiting signal response system constructed and operative in accordance with a preferred embodiment of the invention;

FIG. 2 is a schematic illustration of the call waiting response module of FIG. 1;

FIG. 3 is a schematic illustration of an exemplary prepared list of responses stored in the database of FIG. 2;

FIG. 4 is a block diagram of a novel call waiting response process for the system of FIG. 1; and

FIG. 5 is a schematic illustration of a novel communications device constructed and operative in accordance with a preferred embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the invention may be practiced without these specific details. In other instances, well-known methods, procedures, and components have not been described in detail so as not to obscure the invention.

While the prior art may indeed provide a valuable service to telephone users; it may also provide a source of irritation and inconvenience as well. Applicants have realized that a system for managing and sending of pre-prepared call waiting responses may prevent this irritation and convenience. FIG. 1, to which reference is now made, illustrates a novel call waiting signal response system 100, constructed and operative in accordance with a preferred embodiment of the invention.

Communications devices 110 may be any communications devices suitable for conducting a telephone conversation via a communications network such as mobile telephone network 200. The users (not shown) of devices 110A and 110B may be actively engaged in a telephone conversation as depicted by broad double sided arrow 120. It will be appreciated that arrow 120 may indicate a logical connection between devices 110A and 110B. The actual telephonic connection between devices 110A and 110B may actually be routed through mobile network switch 210.

As illustrated by dotted broad arrows 220, while devices 110A and 110B may be connected, the user of device 110C may call device 110A via mobile network switch 210. Mobile network switch 210 may comprise the functionality of any suitable mobile network switch such as are known in the art. However, in accordance with a preferred embodiment of the invention, mobile network switch 210 may also comprise call waiting response module 220 to manage call waiting signal responses for subscribers of mobile network 200.

Mobile network switch 210 may forward the call to device 110A with a call waiting. As in the prior art, such an attempt to call device 110A while it may be actively engaged in a telephone call may result in a call waiting signal on device 110A. However, in accordance with a preferred embodiment of the invention, the user of device 110A may input a simple response code to send a pre-prepared response to device 110C via call waiting response module 220. For example, the user may input “*2”, where the asterisk may indicate that it is a call waiting response code, and the “2” may indicate that the second stored response should be sent to device 110C. It will be appreciated that the use of an asterisk to indicate call waiting responses may be exemplary; the invention may include any other symbol that devices 110 may use to differentiate between call waiting responses and other functions for devices 110.

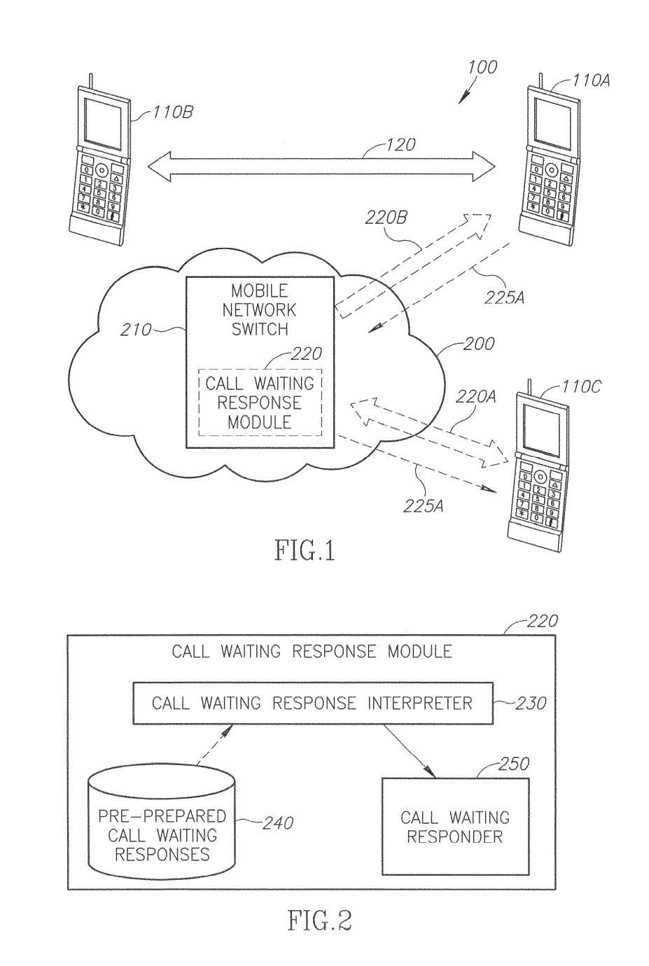

Reference is now made to FIG. 2 which illustrates an exemplary call waiting response module 220 constructed and operative in accordance with a preferred embodiment of the invention. Module 220 may comprise a call waiting response interpreter 230, a prepared call waiting responses database 240 and a call waiting responder 250.

Database 240 may store pre-prepared responses on behalf of subscribers of mobile network 200 such as, for example, the user of device 110A. In accordance with a preferred embodiment of the invention, the pre-prepared responses may be audio responses previously recorded by the subscribers themselves. Alternatively, the subscribers may select from a list of standard responses offered by the operator of mobile network 200. The responses may also include actions, as will be described hereinbelow.

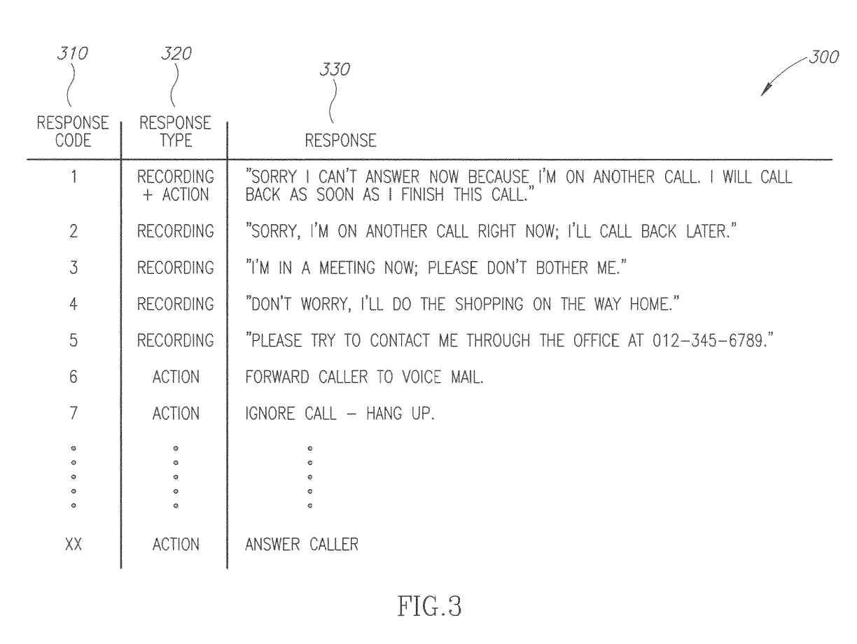

FIG. 3, to which reference is now made, illustrates an exemplary prepared response list 400 stored in database 240 on behalf of a subscriber such as the user of device 110A. Such a list 300 may typically comprise a response code 310, a response type 320 and a response 330. Response code 310 may correspond to a code that the user of device 110A may enter in response to a call waiting signal. It will be appreciated that response codes 310 as listed may be exemplary; other codes may be included in the invention. Furthermore, response codes 310 may typically be preceded by another symbol to indicate that they are response codes. For example, the user of device 110A may first enter an asterisk to indicate a call waiting response, and then the actual response code. It will be appreciated that the contents of response list may be exemplary; in practice, different codes, types and responses may be implemented.

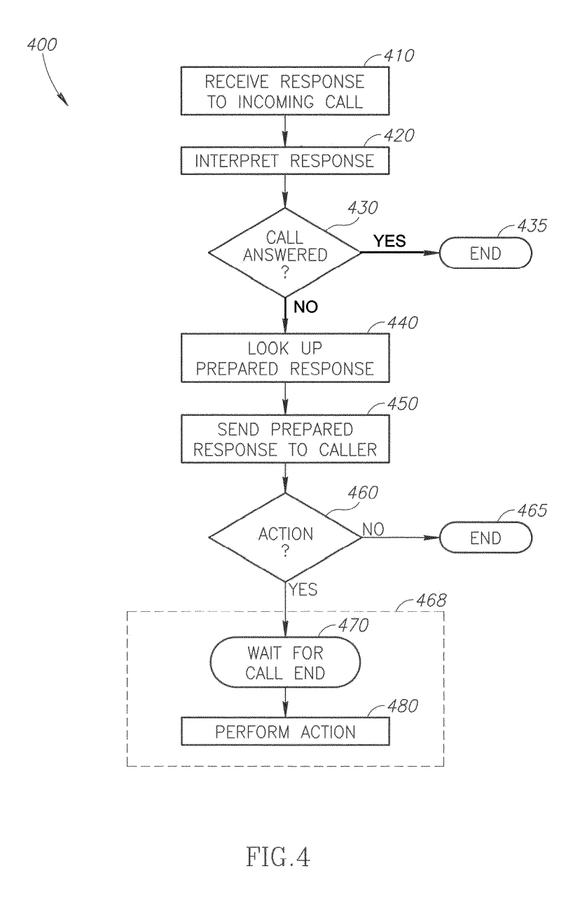

FIG. 4, to which reference is now made, illustrates a novel call waiting response process 400 by which mobile network switch 210 with module 220 installed may enable the user of device 110A to send a pre-prepared response to the user of device 110C without significantly impacting on the quality of the ongoing conversation with the user of device 110B.

As shown in FIG. 1, broad dotted arrows 220 may indicate an attempt to call device 110A from device 110B. Dotted arrows 225A may indicate a response from device 110A routed through switch 210.

Call waiting response module 220 may receive (step 410) the response from device 110A. Call waiting response interpreter 230 may interpret (step 420) the response. If the response may be to answer the call (step 430), the process may end (step 435); no further processing may be necessary by module 220 and normal processing by switch 210 may continue. It will be appreciated that the implementation of this feature may be contingent on the functionality of a given switch 210. Accordingly, in some cases, it may be preferable to establish that the user wishes to answer the call at an earlier stage before invoking module 220 for interpretation.

If the call was not answered (step 430), interpreter 230 may lookup (step 440) the received response in prepared call waiting responses database 240. For example, if the received response corresponded with a response code 310 of “2”, then the associated response 330 may be an audio recording of the user of device 110A saying: “Sorry, I'm on another call right now; I'll call back later.” It will be appreciated that the received response may not correspond with any of the response codes 310 associated with the owner of device 110A. For example, the user may have made a mistake when inputting the code. To allow for such cases, a default response may be previously designated on a system or user level.

Call waiting responder 250 may send (step 450) the associated response 330 to device 110C. It will be appreciated that responder 250 may use pre-existing functionality of switch 210 to send the audio response to device 110C. It will be appreciated that when response type 320 may be “action”, it may not be relevant to send anything to device 110B.

For example, if response 330 may be “Ignore call—hang up” responder 250 there may not be anything to send to device 110C.

If response type 320 may not indicate (step 460) an action, then processing by module 220 may end (step 465). Otherwise responder 460 may process (step 468) the indicated action. As indicated in list 300, some responses may consist of actions or combinations of recordings and actions. For example, response type 320 corresponding to a “1” for response code 310 may indicate both a recording and an action. Accordingly, responder 250 may send an audio recording of: “Sorry, I can't answer right now because I'm on another call. I will call back as soon as I finish the call” as described hereinabove for step 450.” Responder 250 may wait (step 470) for the current call with device 110B end. Once the call has ended, responder may use the built-in functionality of switch 210 to perform (step 480) the required action, i.e. to initiate a call from device 110A to device 110C.

It will be appreciated that depending on the indicated action in response 330, step 468 may be configured differently. For example, if response 330 may be “forward caller to voice mail”, there may be no need for step 470, as there may be no need to wait for the current call to end.

It will be appreciated that the implementation of call waiting response module 220 as an integrated module within mobile network switch 210 may be exemplary. The functionality of module 220 may also be implemented externally to switch 210; for example, as a response server that may be invoked by switch 210 whenever a call waiting situation may be detected. Such a response server may also be configured to communicate with devices 110 over a data connection instead of the voice connection that switches 210 may normally use when completing connections between devices 110.

Accordingly, device 110A may be configured so that when an incoming call may be detected from, for example, device 110C, a data connection may be opened to a call waiting response server analogous to module 220. Device 110A may then send its user's response codes to the server via the data connection. The server may then process the codes in generally the same manner as module 220. If an audio response may be required, the server may be configured to send the relevant recording to switch 210 for forwarding to device 110C as in the previous embodiments.

It will be appreciated that most telephones as currently configured may not be capable of sending response codes in response to call waiting. Standard telephone applications (i.e. “phone apps”) may typically restrict user initiated communications with switch 210 to either the acceptance or rejection an incoming call; users may not be able to send codes to switch 210.

In accordance with a preferred embodiment of the invention, the phone app of devices 110 may be modified to enable users to send response codes to switch 210. Such modification may enable the user of device 110A to send switch 210 a response code prior to answering an incoming call from device 110C. The response code may be transmitted via a control channel between device 110A and switch 210, thus enabling the user of device 110A to respond to the incoming call without effecting a voice connection; therefore maintaining an existing call (if relevant) with device 110B as in FIG. 1.

Alternatively, the phone app may be configured to actually effect a voice connection with switch 210 (but not onward to device 110C) and to send the response code as an analog signal to be decoded by module 220. In such a case, there may be a momentary break in the connection between devices 110A and 110B, when device 110B is put on hold. However, the break may be of such short duration that it may not significantly impact on the conversation between the users of devices 110A and 110B. In fact, it may be expected that the user of device 110B may not even realize that device 110B had been put on hold.

Since it is likely that devices 110 may need to be modified to implement the invention, it may be desirable to implement the entire invention on devices 110 without modifying switches 210. Instead, the functionality of module 220 may be implemented as an executable application on a device 110.

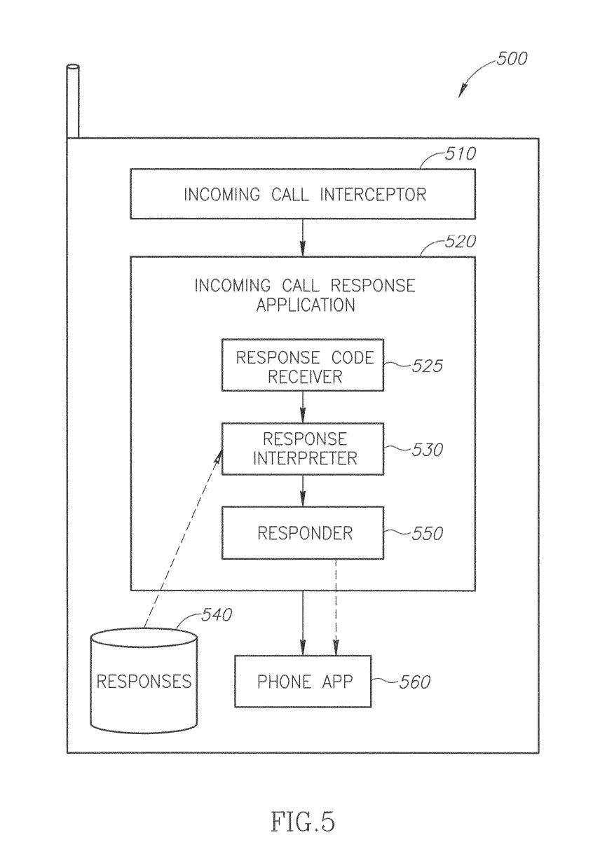

Reference is now made to FIG. 5 which illustrates a novel pre-prepared response enabled communications device 500 constructed and operative in accordance with an alternate preferred embodiment of the invention. As may be typical in prior art communications devices, device 500 may comprise a phone app to control and manage telephone calls between device 500 and other communications devices. Device 500 may also comprise an incoming call interceptor 510, an incoming call response application 520, and a responses database 540.

Device 500 may have an API that may be used to intercept an incoming phone call before it may be fully processed by phone app 560. Interceptor 510 may use such an API to intercept incoming calls so that the user of device 500 may send a pre-prepared response to the incoming call.

Interceptor 510 may invoke incoming call response application 520 whenever an incoming call may be detected. Application 520 may comprise response code receiver 525, response interpreter 530 and responder 550. Receiver 525 may be a routine which may trap user keystrokes for forwarding for processing by response interpreter 530. Receiver 525 may continue running until a valid response code is received or the incoming call is answered/rejected/withdrawn by the caller. If the incoming call may be ended, control may be returned to phone app 560.

Response interpreter 530 may use responses database 540 to interpret the response codes in a manner analogous to that of interpreter 330 using database 340 as described in process 400. Responder 550 may function in a manner similar to that of responder 330. However, instead of using the inbuilt functionality of switch 210 to send responses to the calling device, it may use phone app 560 and or other inbuilt functionality of device 500 to do so. It will be appreciated that in order to send responses to the calling device, it may be necessary for device 500 to maintain two simultaneous voice connections—one with the incoming call device, and one with a device to which it is already connected for a conversation. It will be appreciated that older devices 500 and/or networks 200 may not support such functionality. In such cases, device 500 may be configured to send non voice responses such as email and/or SMS to the calling device. Alternatively, device 500 may effect a data connection with a VOIP gateway to immediately call back the incoming caller with the recorded response.

Applicants have realized that the invention may be of use to communications network subscribers even when they are not already engaged in a telephone conversation. The invention may be applied to any incoming call situation, even if it is not a call waiting situation. In accordance with a preferred embodiment of the invention, the user of a device 110 may send a response code in response to any incoming call, whether device 110 is already engaged in a telephone conversation or not.

It will also be appreciated that the representation of network 200 as a mobile network is exemplary. The invention may be implemented on any telephonic network.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A prepared response communication system comprising
a receiver to receive response codes from at least a first communications device; and
a call response module to respond in accordance with said response codes to an attempt by a second communications device to call said first communications device.

2. The system according to claim 1 and wherein said call response module comprises:
a response code interpreter to interpret said response codes received from said first communications device while said second communications device attempts to call said first communications device; and
a responder to at least send a pre-prepared response on behalf of said first communications device to said second communications device as per interpretation by said interpreter.

3. The system according to claim 2 and wherein said call response module also comprises a database of pre-prepared responses associated with said response codes.

4. The system according to claim 3 and wherein said pre-prepared responses are at least one of: pre-recorded audio messages and actions.

5. The system according to claim 1 and wherein said call response module is configured to process said response codes in response to a call waiting situation, wherein such situation occurs when said first communications device is already engaged with in a call with a third communications device when called by said second communications device.

6. The system according to claim 4 and wherein said actions are at least one of: answer, hang up, call back, send an SMS, send an email, and set a reminder.

7. The system according to claim 1 and wherein said call response module is implemented as part of a communications switch.

8. The system according to claim 1 and wherein said call response module is implemented as a server in communication with at least one of said first communications device and a communications switch.

9. The system according to claim 1 and wherein said response codes are received via a voice connection.

10. The system according to claim 1 and wherein said response codes are received via a data connection between said first communications device and said call waiting response module.

11. A method to be implemented on a computing device for sending prepared responses to an incoming caller, the method comprising:
receiving a response code from a first communications device, wherein said first communications device is being called by a second communications device;
interpreting said response code as a desired response; and
responding to said second communications device in accordance with said desired response.

12. The method according to claim 11 and wherein said interpreting comprises looking up said response code in a database of pre-prepared said desired responses; wherein at least one of said desired responses are associated with a user of said first communications device.

13. The method according to claim 11 and wherein said responding comprises at least sending a pre-recorded audio response to said second communications device on behalf of a user of said first communications device.

14. The method according to claim 11 and wherein said responding comprises at least performing a pre-selected action on behalf of a user of said first communications device.

15. The method according to claim 14 and wherein said pre-selected action is at least one of: hanging up, answering, sending an electronic message, and calling back said second communications device.

16. The method according to claim 15 and wherein said calling back comprises at least one of: calling back said second communications device according to pre-determined timing schedule, and calling back said second communications device upon completion of a current call with another communications device.

17. The method according to claim 11 and wherein said computing device is integrated within a communications switch.

18. The method according to claim 11 and wherein said computing device is response server implemented independently of a communications switch.

19. The method according to claim 11 and wherein said receiving is via at least one of a data connection and a voice connection.

20. A communications device comprising:
an incoming call interceptor to intercept incoming calls from at least a second device; and
an incoming call response application to enable a user of said communications device to respond in a pre-determined manner to said second device.

21. The device according to claim 20 and wherein said incoming call response application comprises:
a response code receiver to receive said response codes input by said user;
a response interpreter to interpret said response codes as desired responses by said user to said incoming calls; and
a responder to forward said desired responses as necessary to at least said second communications device.

22. The device according to claim 21 and also comprising a responses database to associate said response codes to said desired responses.

23. The device according to claim 20 and wherein said interceptor comprises means to intercept said incoming phone call prior to their processing by a phone application.

24. The device according to claim 22 and wherein said desired responses are at least one of a pre-recorded message and an action.

25. The device according to claim 24 and wherein said responder comprises means to answer said incoming call and at least initiate play of said pre-recorded message as indicated by said desired responses.

26. The device according to claim 22 and wherein said responder comprises means to launch a built-in phone application to call back said second communications device according to a schedule indicated by said desired responses.

27. The device according to claim 26 and wherein said schedule is at least one of: a set time of day, a number of hours/minutes in the future, and upon completion of an ongoing call with another communications device.

28. The device according to claim 20 and wherein said interceptor is configurable to intercept incoming “call waiting” calls, wherein said communications device is already engaged in a call with another communications device.

29. A method implementable on a communications device for providing prepared responses to incoming telephone calls, the method comprising:
intercepting an incoming call from a second communications device;
receiving a user-input response code; and
responding to said incoming call with a prepared response associated with said response code.

30. The method according to claim 29 and also comprising interpreting said response code as a desired response by looking it up in a pre-prepared response database.

31. The method according to claim 30 and wherein said desired response is at least one of a pre-recorded message and an action.

32. The method according to claim 31 and wherein said responding comprises answering said incoming call and initiating the play of said pre-recorded message.

33. The method according to claim 31 and wherein said responding comprises calling back said second communications device in accordance with timing indicated by said action.

34. The method according to claim 33 and wherein said timing may be upon conclusion of a current call with another communications device.
